(19) United States
(12) Patent Application Publication
(10) Pub. No.: US 2006/0173776 A1
(43) Pub. Date: Aug. 3, 2006

(54) A Method of Authentication

(75) Inventors: Barry Shalley, Singapore (SG); Bruce Simpson, Tokoroa (NZ)

Correspondence Address: Marina Larson & Associates, LLC, P.O. BOX 4928, DILLON, CO, 80435, US

(73) Assignee: Barry Shalley, Singapore (SG)

(21) Appl. No.: 11/275,718

(22) Filed: Jan. 25, 2006

Related U.S. Application Data
(60) Provisional application No. 60/647,851, filed on Jan. 28, 2005.

(51) Int. Cl. G06Q 40/00

(52) U.S. Cl. 705/39

(57) ABSTRACT

The present invention relates to the authentication of parties involved in transactions performed remotely over a network, such as the Internet. When a first party initiates a transaction with a second party, the second party can request authentication of the first party. Authentication is carried out by sending a communication to the first party, which includes a redirection to a transaction specific location,. At the transaction specific location the first party is required to approve the transaction as well as answer some identifying question or questions. If the transaction is approved and the question or questions answered correctly, the second party is informed that the transaction can be approved.

### FIELD OF THE INVENTION

The invention relates to eCommerce transactions, and more particularly, to a method and process for verifying or authenticating eCommerce transactions between an Initiating Party, a Receiving Party(s) and an Authentication Manager.

### BACKGROUND

Online card fraud acts as an inhibitor to eCommerce for both commercial and non commercial transactions. Shoppers are fearful about the theft of credit card data online. Governmental agencies are concerned for the protection of official and private information.

Maintaining a high degree of confidence and trust in card brands is crucial to building eCommerce transactional volume for banks and merchants. Credit card companies therefore continue to invest in protecting all participants in their payment systems.

Companies selling via the Internet typically absorb the costs of disputes with shoppers and of any fraudulent transactions they suffer. The primary reason is that online transactions lack a physical receipt that has been signed by the shopper and can later be verified. Selling online is therefore a riskier transaction for a merchant than selling face to face. Online merchants, unless they are Verified By Visa for example, and/or have minimal fraud based transactions (under MasterCard's SecureCode Zero Liability programme), suffer the cost of all chargeback disputes and the original fee. By contrast, in the card-present world, if there is a signed receipt, the merchant is protected.

Authentication of an online transaction usually requires two elements:
Authentication of the purchaser's identity, and
Authentication of their right to use the card being submitted.

There are some relatively complex methods, such as digital signatures, which can assist with the first element, and other sophisticated methods that can assist with the second, but typically a different process is used for each element. To date, alternative authentication methods such as digital signatures have not been well received by shoppers—something that represents a major hurdle to systems that rely on such mechanisms.

In U.S. Pat. No. 5,963,924 a system is disclosed in which, once a consumer has decided to make a purchase from the merchant, the system requests a user name and wallet password, display merchant and order information, requests that a user select a payment instrument from the wallet, and displays and captures order acknowledgement and digital receipt.

U.S. Pat. No. 6,725,381 describes data transfer through computer networks and, in particular, a mechanism by which a specific intended recipient of a delivered document can be authenticated without prior participation by the intended recipient. The sender specifies secret information which is believed to be known to the intended recipient and to few others, if any. The recipient must supply this information to download the delivered document. Since the intended recipient may not be expecting the document delivery and may not know the nature of the requisite information, the sender can also supply a prompt by which the recipient can surmise the requisite secret information.

The system disclosed in U.S. Pat. No. 6,704,039 includes 2 stations, an automated teller machine (ATM) and an ID station—such that a subscriber wanting to perform a variety of financial transactions, whether positioned in front of an e-mail station having ATM capability at one of the network offices or in front of a stand-alone remote e-mail/ATM network accessing station, could do so by simply entering a discrete password and allowing the system to take a current digital photograph, fingerprint, and/or voice pattern sample and compare it to the digital photograph and other data already on file in its computer database. When money is transferred to another network subscriber, the recipient subscriber can choose to receive a message about the transfer via e-mail, pager, voice mail, or mobile phone, after which the recipient subscriber can proceed to the nearest network-accessing unit having ATM capability to obtain all or part of the transferred money.

Currently in use systems include “Verified by Visa”, which is illustrated by FIG. 1. FIG. 1 shows the steps involved in an online transaction. At step 11 the cardholder enters his or her Visa card number and submits an order with the participating merchant. Every time registered cardholders make a purchase at a participating Verified by Visa Merchant, they are automatically prompted by a Verified by Visa window to enter their personalized password and authenticate themselves. This takes place at step 12. After the card issuer has authenticated the cardholder's identity, the transaction is then processed at step 13. Verified by Visa has the potential to reduce Internet purchasing fraud and customer disputes because only the cardholder and Issuer know the cardholder's password.

In relation to online banking, ASB Bank offers a verification system called Netcode (http://www.asbbank.co.nz/netcode/) as illustrated by FIG. 2. Once registered for Netcode, whenever a user requests a transaction in excess of the $2,500 Netcode daily limit at step 21, a computer generated Netcode will automatically be sent to the user's mobile telephone at step 22. The user's mobile telephone number will be confirmed upon registration. The user is then asked to enter the Netcode onto the online banking screen at step 23 to confirm his identity, before the transaction is processed at step 24. Other banks use similar systems for verifying the creation of new account payees prior to activating them for funds transfer. Once activated any number/ amount of transactions/funds transfers can then be made to the activated payee.

It is an object of the present invention to overcome any disadvantages in the prior art, or at least to provide the public with a useful choice.

### SUMMARY OF THE INVENTION

In a first aspect of the present invention, a method for authenticating the identity of a first party in a transaction between the first party and a second party performed on a communications network, comprises the steps of:

receiving registration data specific to the first party;

receiving from the second party an authentication request together with data related to the first party;

verifying that the data relates to the first party;

sending a communication to a predetermined network location known to the first party, the communication including details of a transaction specific location on the network;

receiving a response from the first party from the transaction specific location; and

confirming approval or decline of the transaction to the second party depending on the response from the first party.

Preferably, the method further comprises the step of creating at least one question at the transaction specific location, the question relating to the registration data or to a previous transaction made by the first party. Preferably, the method further comprises the step of determining if the response from the first party includes a correct answer to the question, wherein approval of the transaction is only confirmed to the second party if a correct answer is included in the response from the first party.

Preferably, the method further includes the step of determining if a response is received from the first party within a predetermined time.

Preferably, the step of sending a communication to a predetermined network location includes sending an email to a predetermined email address. An alternative form of communication, such as a short message service (SMS) message may be used.

Preferably, the details of a transaction specific location are provided in the communication as a hyperlink to the transaction specific location. Preferably, the hyperlink contains a unique identifier. The hyperlink can be included in an email, SMS message or any other suitable network communication.

Preferably, the method further includes the step of creating a transaction specific location on the network. Preferably, the method further includes the step of dynamically creating a form and making the form available at the transaction specific location, the form including at least one question. Preferably, the at least one question is selected or created from a plurality of possible questions. Different questions can be randomly created for different transactions, providing better security. Preferably, the method further comprises the step of providing the first party with an option to approve or refuse the transaction at the transaction specific location.

Preferably, the method further includes the step of providing the first party with an option, a prompt or a command to alter the predetermined network location.

Preferably, the first party is an online shopper and the second party is an online merchant. Alternatively, the first party may be a voter and the second party an electoral authority. In another alternative, the first party is a bank customer and the second party is a bank offering Internet banking services.

The method may further include the step of requesting credit card details from the first party at the transaction specific location.

In a second aspect of the invention, a method for authenticating the identity of a customer in a transaction between the customer and a merchant performed over the Internet, comprises the steps of:

receiving at an authentication manager on the network registration data specific to the customer;

receiving at the authentication manager from the merchant an authentication request together with data related to the customer;

verifying at the authentication manager that the data relates to the customer;

creating a transaction specific website, the website including a form for responding to at least one question;

sending an email from the authentication manager to a predetermined email address known to the customer, the email including a hyperlink to the transaction specific website;

receiving at the authentication manager a response from the customer to the question on the transaction specific website; and

sending an approval or decline of the transaction message from the authentication manager to the merchant depending on the response from the customer.

In a third aspect of the invention, a system for authenticating a first party in a transaction between the first party and a second party performed on a communications network, comprises an authentication manager connected to the network, in use the authentication manager performing the steps of either the first or second aspect of the invention.

The authentication manager may be implemented as software existing on one or several servers.

The banking industry is always looking for ways of protecting data so that even if a customer's card is compromised it is useless to a criminal. The present invention is a step in that direction. Not only does a customer require his card details, he also needs to know a location to go to (the predetermined network location e.g. his designated email address) and other personal/transactional information in order to complete a transaction.

The present invention represents pragmatic trade-off between convenience and security. The method of the present invention involves no extra hardware, software, encryption, PINs or other technology for the first party (card owner). The second party (merchant) needs no extra hardware and needs only make a single automated online “authentication” call to an authentication manager to verify that the cardholder is the person legally entitled to use the card. The system can automatically identify attempted fraudulent use of a card and immediately advise the issuing authority. Furthermore, due to the relatively low cost of implementation and operation, the time to implementation and cost per transaction is very low.

### BRIEF DESCRIPTION OF THE DRAWINGS

Examples of the present invention will now be described in detail with reference to the accompanying drawings, in which;

FIG. 1 is a diagram illustrating the Verified by Visa process;

FIG. 2 is a diagram illustrating the Netcode process;

FIG. 3 is a block diagram showing a transaction or multiple receiving party process including an authentication method in accordance with the present invention;

FIG. 4 shows an email sent to the initiating party requesting a response;

FIG. 5 shows an order confirmation email to the initiating party and a response form including authentication questions;

FIG. 6 shows an order approved or declined screen at a transaction specific location on the network;

FIG. 7 shows an order approved or declined email to the receiving party;

FIG. 8 shows a screen for adding a new account;

FIG. 9 shows an account deleted email to the receiving party; and

FIG. 10 is a block diagram of the voting or single receiving party process.

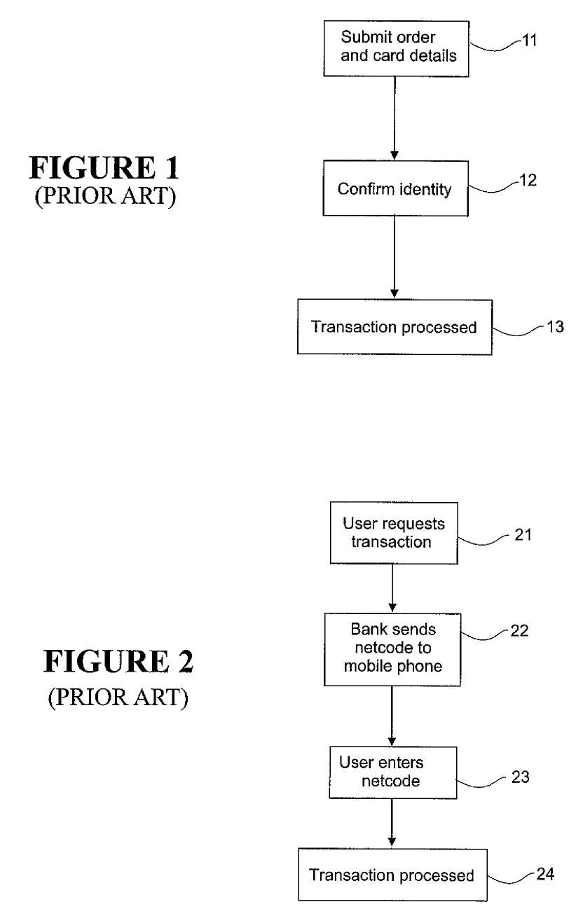

### DETAILED DESCRIPTION

The present invention relates to a method of authenticating parties involved in electronic transactions. Generally speaking, there are five methods/things for authenticating an identity of a party. They are:

1. Something the party knows;

2. Something the party owns;

3. Something the party is;

4. The party being at a particular place (at a particular time); and

5. Authentication established by a trusted third party.

Depending exclusively on any of the methods 1-4 is generally inadequate and multi-token authentication systems are the norm. For example, bank ATM systems use a combination of methods 1 and 2 in the form of passwords (PINs) and bankcards.

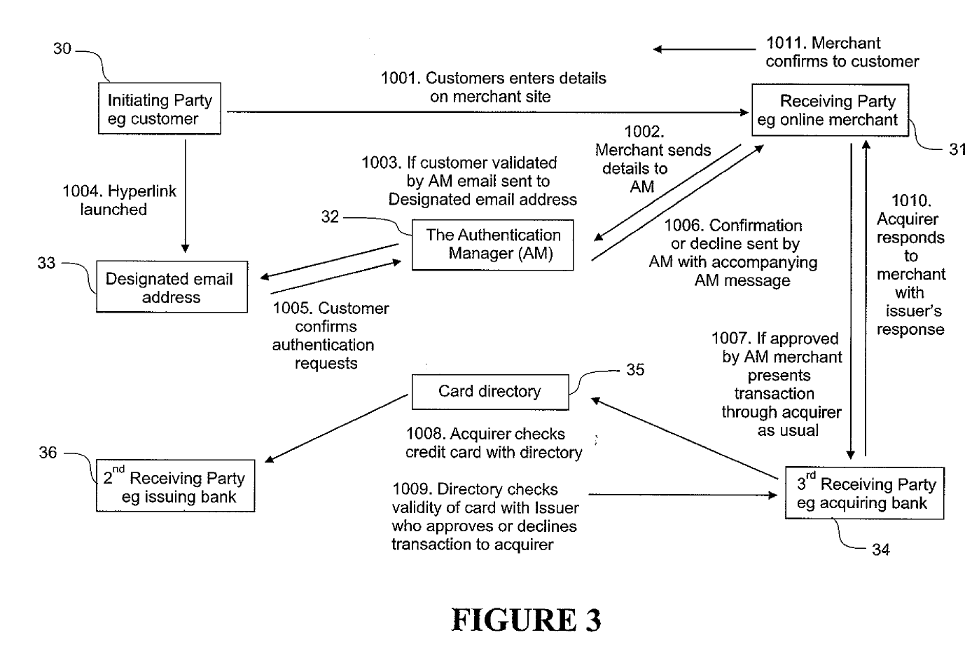

FIG. 3 illustrates an example of a transaction incorporating the present invention. There are a number of parties involved in any transaction utilising an authentication method in accordance with the present invention. They are:

1. The “Initiating Party”.

The Initiating Party is the party who initiates a transaction or request or right.

2. The “Receiving Party”.

The first Receiving Party is the one with whom the Initiating party wishes to either
a. exercise a right (for example voting); or
b. request confidential information; or
c. complete an ecommerce transaction

Additional, receiving parties may include issuing and acquiring banks in an eCommerce context who may deliver the transaction through payment or processing gateway service providers.

3. The “Authentication Manager”.

The Authentication Manager is the party responsible for routing the necessary messages used to authenticate the identity of the Initiating party to the Receiving Party with regard to electronic transactions and or commerce.

The Authentication Manager may be directly managed by the company wanting authentication, for example a bank, research institute or government body, or indirectly through their secure service providers.

FIG. 3 shows an initiating party (or cardholder) 30, a receiving party (or merchant) 31, and an Authentication Manager 32. In a first step 1001 the cardholder 30 initiates a transaction by entering details, such as card details and selection of an item for purchase, on a merchant website 31. Within the merchant website the cardholder selects goods or services and proceeds to the merchant checkout page. Here, the card and expiry date details, amongst others, is requested.

These details are transferred to the merchant website via the Internet using secure socket layer (SSL) protocols or equivalent protocols. The merchant then sends an authentication query to the Authentication Manager at step 1002 again using SSL via the Internet. The merchant may send item level data to the Authentication Manager with the query, so the Authentication Manager can dynamically create forms based also on current transaction details for subsequent transactions if the Authentication Manager chooses to. The merchant must have some form of link to the Authentication manager, such as an embedded hyperlink on his webpage.

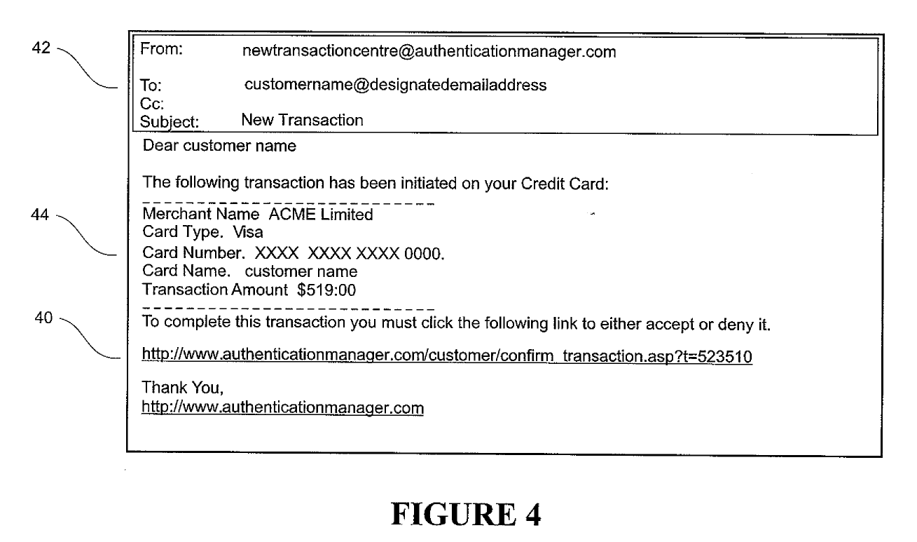

At step 1003 the Authentication Manager determines whether the cardholder details from the merchant are valid by comparing them with a database of registered cardholders. If they are valid, the Authentication Manager sends an email to the cardholder's designated email address 33 via the Internet. An example email 42 is shown in FIG. 4. The email 42 identifies transaction details 44 and includes a hyperlink 40 to a transaction specific URL that must be followed in order to complete the transaction. The Designated email address email notification to the cardholder can be viewed by any device that can activate a hyperlink on the internet and therefore send authenticated responses.

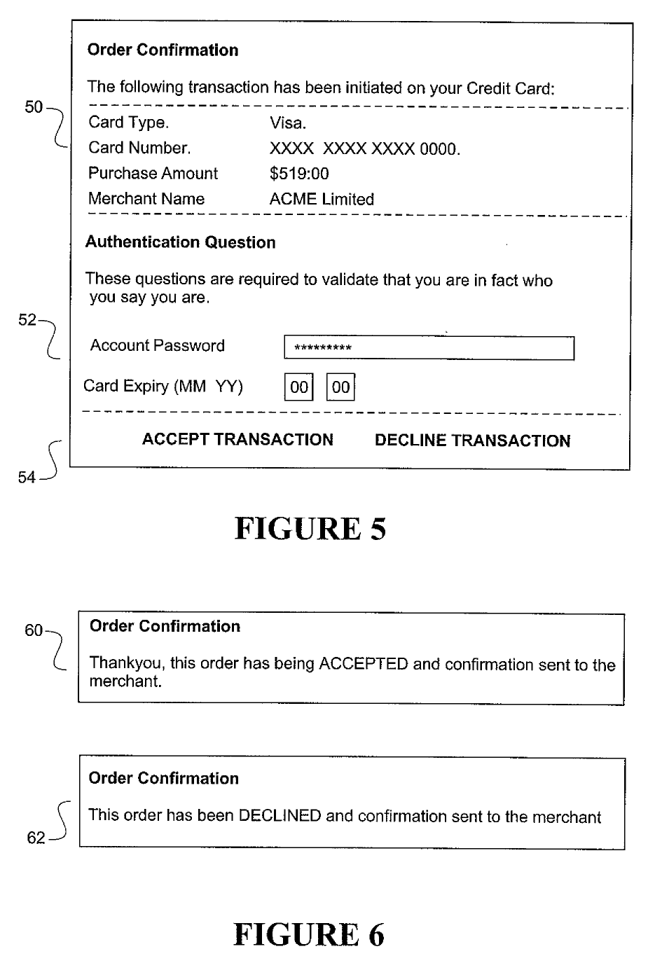

In step 1004 the hyperlink 40 takes the cardholder to a website that offers the cardholder the choice of accepting or declining the transaction as seen in FIG. 5. The cardholder is shown details of the transaction 50 and must answer questions 52 to prove his identity. The questions are provided in a form that is sent to the Authentication Manager on completion of the form. These questions are based on information provided by the cardholder during registration with the Authentication Manager, as will be described in detail below. Alternatively or in addition, the Authentication Manager may require confirmation of details related to a previous transaction, which have been stored by the Authentication Manager. The questions are dynamically created from data stored by the Authentication Manager. There are many different possible questions. In this way, the system ensures that it is not always the same questions that are asked of the cardholder. This adds a further level of security. The cardholder must also enter one of two responses 54, either approval or decline. This is indicated as step 1005 in FIG. 3.

If both the correct answers are given and the cardholder approves the transaction, it will be approved by the Authentication manager to the merchant and the card request is sent to the bank for approval in the usual manner from the merchant. Upon receipt of bank approval, goods are dispatched and the transaction is complete. If the cardholder declines the transaction, it will be declined. If the customer approves the transaction but has entered incorrect answers, the transaction may be declined, depending on bank policy. There is also a set time limit for the user to respond to the email, for example 1 minute. If no response is received by the Authentication Manager in that time, the transaction will be declined.

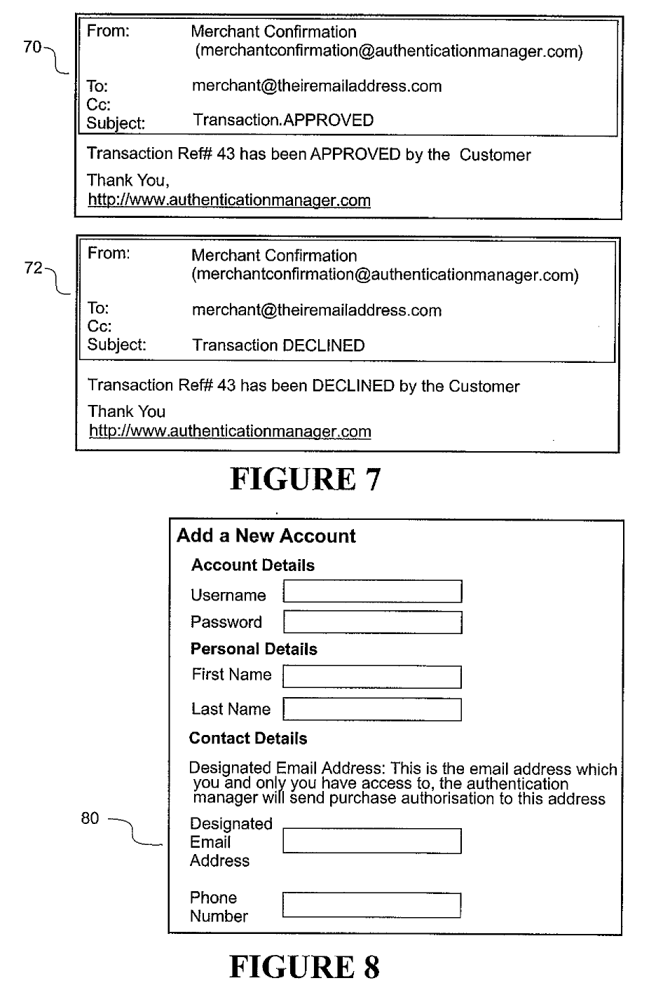

At step 1006 confirmation that the transaction is either approved 60 or declined 62 (purposefully or because of errors) is displayed to the cardholder at the hyperlinked website as shown in FIG. 6. The merchant in turn receives either a confirmation email 70 or a decline email 72 as shown in FIG. 7.

In order to complete the transaction funds must be transferred from the cardholder's or card issuer's bank (or issuing bank) to the merchant's bank (or acquiring bank). The merchant's bank 34, the issuing bank 36 and the card directory 35 are shown in FIG. 3.

At step 1007 the merchant, if the transaction has been approved by the Authentication Manager, sends billing information to the merchant's bank in the usual manner using SSL via the Internet. Ideally, in step 1006 the Authentication Manager sends the approval information in a form that can be tagged along with the billing information in step 1007. This follows traditional banking methods and does not slow down any subsequent matching process with the Issuing bank. In other words, the Authentication Manager response and the traditional merchant request are jointly sent to the issuing bank 36 for approval. However, the approval information from the Authentication Manager may be sent separately.

At step 1008 the card directory 35 receives a request from the merchant's bank 34, to verify the cardholder details. The issuing bank approves or declines the transaction depending on verification of the cardholder details. At step 1009 the issuing bank 36 sends an approval or decline message to the merchant's bank using SSL via the Internet. The merchant's bank then sends an approval or decline message to the merchant using SSL via the Internet at step 1010.

At step 1011 the merchant confirms the purchase (or confirms that the purchase has been declined) to the cardholder, again using SSL via the Internet.

It is important to note that the authentication process occurs before the issuing bank receives the request to approve the transaction. The result is either an approved transaction or advice of a fraudulent transaction.

A decline following an authentication manager approval may be bank specific and relate to credit worthiness for example.

The Authentication Manager 32 provides an additional element to ordinary transactions—a message in the form of email or its equivalent that is capable of being used on the internet or other communications network. An email is sent from the Authentication Manager to the cardholder for the cardholder to respond to and authenticate the transaction.

If the designated email account has been compromised it will be apparent to the cardholder e.g. the open email flag signals that the email has already been read in the browser, or the hyperlink has been rendered inactive after being responded to. The designated email account may be changed by the cardholder. The Authentication Manager may also periodically prompt or require the cardholder to change the designated email address. Changing the email address is similar to changing a password and increases the security of the system.

The Authentication Manager determines whether the cardholder is in the right place such that the shopper can access online their designated email address email account to respond to the authentication email or form. This Designated email address email account will not be a typical everyday email account but one where only the Authentication Manager communications go. The response from the cardholder is not sent as a separate email but is provided through the hyperlinked website. The “reply-to” option in the email itself is therefore avoided to prevent unwitting abuse of the designated email address email account. The hyperlinked website can be dynamically created for each transaction and can provide a form that when completed, is directed to the Authentication Manager. The use of different URLs for subsequent transactions makes the website more difficult to pharm, spam or search for. The URL used for the hyperlinked website can be recycled for different transactions and different cardholders.

The Authentication Manager may be directly managed by the company wanting authentication, for example a bank, research institute or government body or indirectly through their secure service providers.

If the Authentication Manager is within a banking environment the Authentication Manager systems can add another dimension to the lost fraudulent card list and immediately advise the merchant that the transaction may be fraudulent—thus allowing them to void the transaction rather than waiting any nominal time period for an authentication that will never arrive.

Through the Authentication Manager, any merchant can have online purchases verified. The system not only prevents online card fraud but it also automatically advises card owners whenever unauthorised online use of their card is detected.

The banks may wish as an alternative to not to capture the credit card details at the merchant level but at the Authentication Manager level. This may assist with preventing any fraud that may originate from the merchant.

What happens to a cardholder when they first register with the Authentication Manager will depend upon whether they are giving details within a Company Owner controlled environment or a third party controlled Authentication Manager environment. An example of a company controlled environment is an issuing bank, which manages its own Authentication Manager. The issuing bank will already know much of the required cardholder information prior to registration with the Authentication Manager. An example of a third party controlled Authentication Manager environment is a third party payment transactional processor, independent of the receiving party.

As shown in FIG. 8, when a cardholder registers for the first time with a company owned Authentication Manager the cardholder is asked to enter the one aspect of the security system that the company (a bank for example) does not already possess—the proposed Designated email address 80. The bank will already have details such as the card number and expiry date. They may also be asked to provide some personal information, such as their age, date of birth or mother's maiden name, or some information that only they would know, such as details of other bank accounts. Some or all of this information is then requested by the Authentication Manager in step 1005 shown in FIG. 3.

These details are typically held in the bank's own/primary Access Control Servers (ACS).

When a cardholder registers for the first time with a third party controlled Authentication Manager, they are asked to enter, as a minimum, details of:

1. Their card number,

2. Expiry date, and

3. Their proposed Designated email address.

The card number is treated differently. The card number is used only to derive a hash key by some algorithm and thereafter deleted. The cardholder account therefore holds a hash key and expiry date. As a result, if the Authentication Manager's files become compromised, then card numbers are not available. Card numbers cannot be derived from that hash key, as different card numbers could have the same resulting hash key.

The structure used to enable this takes the form of a secondary or floating ACS (i.e. remote to the individual bank's primary Access Control Servers), with cleansed data held by the Authentication Manager and full details being held on the individual bank's Access Control Servers. This “cleansed” floating ACS is an authentication manager concept to allow the system to operate within banking regulations that might otherwise prohibit the centralisation of all banking data that might be compromised.

Another safeguard at the point of registration is that the card cannot be used for a period of a billing cycle following registration (i.e. until receipt of the card billing statement) and a protection fee will be charged to that card. This ensures that if registration is not real it will appear on the card statement and alert the card owner that there has been an attempt to use their card.

Additional details such as card type can be added at various times. Further capture of cardholder details will be driven by the nature of reporting that a card organization requires when analyzing why a card charge is declined for example.

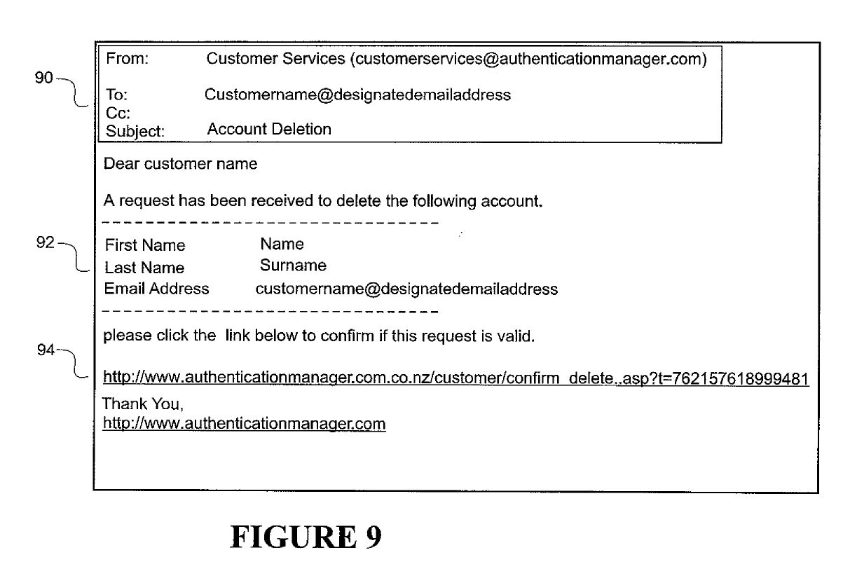

The registration information may be amended or deleted. Again the same process of authentication or verifying any changes is followed as shown in FIG. 9, where the email 90 includes details of the changes 92 and a hyperlink to confirm 94.

At some stage the Authentication Manager database will automatically identify the card number as a registered member of the Authentication manager service, much like Verify by Visa knows that the visa card is Verified by Visa. Until then the customer has to enter the Authentication Manger registration process. If a merchant or customer tries to bypass the system the issuer tells the merchant that they have to engage the Authentication Manager before any funds are transferred.

The Authentication Manager advice to the merchant approving the transaction will either accompany the merchant request of the acquiring bank 34 or be sent directly to the issuing bank 36 to file away and match later if required. Alternatively, it can be sent in both directions, i.e. to the acquirer and issuer, at the same time.

If a cardholder frequently declines or times out, the issuing bank will be informed to prompt a follow up with that cardholder.

The present invention may also be used to authenticate regulatory requirements for voting or similar e-Government activity. Accordingly, in the context of the present invention the term “transaction” encompasses non-commercial exchanges such as voting or other information or decision transfers.

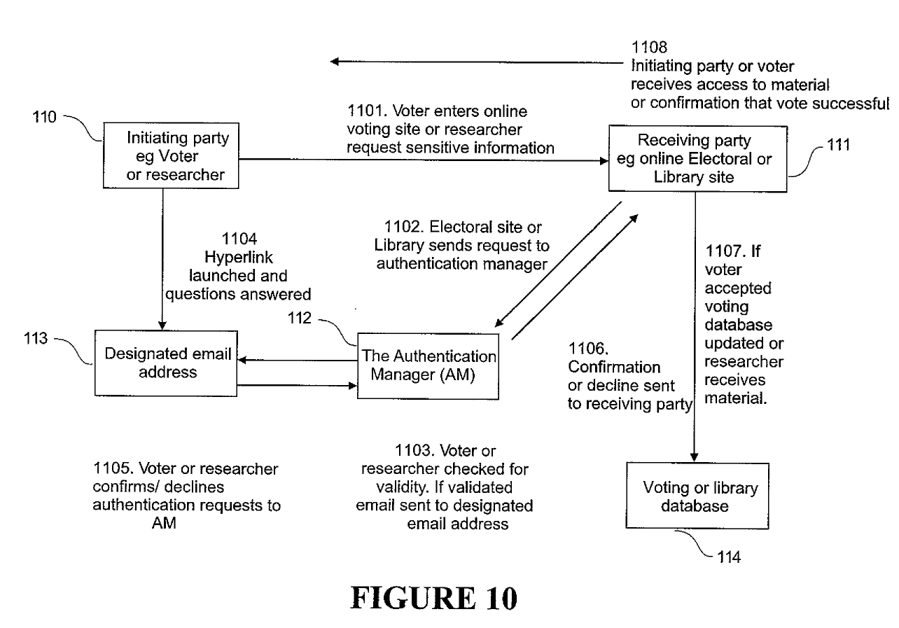

For a voting process the cardholder becomes the voter, and the merchant becomes the local electoral office website. FIG. 10 illustrates a voting process incorporating the present invention. At step 1101 the voter 110 completes an online voting form on the electorate website. Key information requested on the website might be Inland Revenue number or a social security number or some other personal identification number. The electoral office 111 then sends an authentication request to the Authentication Manager 112, at step 1102. At step 1103, the Authentication manager identifies the voter as valid and sends a request for authentication to the designated email address 113 of the voter. The voter then responds to the email at step 1104 by following a hyperlink in the email. At step 1105 the voter confirms or declines the authentication request at the hyperlinked address. The Authentication manager then sends a confirm or decline message to the electoral office at step 1106. At step 1107, if the vote is accepted, the voting database 114 at the electoral office is appropriately updated. Finally, at step 1108, the voter is informed by the lectoral website that the vote was successful.

Another application of the present invention is to transactions between a customer and a bank that offers Internet banking. In this context, the bank controls the Authentication manager.

The authentication method of the present invention is equally applicable to requests for confidential information made over the Internet or other communications network.

1. A method for authenticating the identity of a first party in a transaction between the first party and a second party performed on a communications network, comprising the steps of:
receiving registration data specific to the first party;
receiving from the second party an authentication request together with data related to the first party;
verifying that the data relates to the first party;
sending a communication to a predetermined network location known to the first party, the communication including details of a transaction specific location on the network;
receiving a response from the first party from the transaction specific location; and
confirming approval or decline of the transaction to the second party depending on the response from the first party.

2. A method according to claim 1, further comprising the step of creating at least one question at the transaction specific location, the question relating to the registration data or relating to a first party transaction.

3. A method according to claim 2, further comprising the step of determining if the response from the first party includes a correct answer to the question, wherein approval of the transaction is only confirmed to the second party if a correct answer is included in the response from the first party.

4. A method according to claim 1, further including the step of determining if a response is received from the first party within a predetermined time.

5. A method according to claim 1, wherein the step of sending a communication to a predetermined network location includes sending an email to a predetermined email address.

6. A method according to claim 1, wherein the details of a transaction specific location are provided in the communication as a hyperlink to the transaction specific location.

7. A method according to claim 6, wherein the hyperlink contains a unique identifier.

8. A method according to claim 6 or 7, further including the step of creating a transaction specific location on the network.

9. A method according to claim 8, further including the step of dynamically creating a form and making the form available at the transaction specific location, the form including at least one question.

10. A method according to claim 9, wherein the at least one question is selected or created from a plurality of possible questions.

11. A method according to claim 1, further comprising the step of providing the first party with an option to approve or refuse the transaction at the transaction specific location.

12. A method according to claim 1, further comprising the step of providing the first party with an option, prompt or command to alter the predetermined network location.

13. A method according to claim 1, wherein the first party is an online shopper, a voter or a bank customer and the second party is an online merchant, an electoral authority or a bank.

14. A method according to claim 1, further including the step of requesting credit card details from the first party at the transaction specific location.

15. A method for authenticating the identity of a customer in a transaction between the customer and a merchant performed over the Internet, comprising the steps of:
receiving at an authentication manager on the network registration data specific to the customer;
receiving at the authentication manager from the merchant an authentication request together with data related to the customer;
verifying at the authentication manager that the identifying data relates to the customer;
creating a transaction unique website, the website including a form for responding to at least one question;
sending an email from the authentication manger to a predetermined email address known to the customer, the email including a hyperlink to the transaction specific website;
receiving at the authentication manager a response from the customer to the question on the transaction specific website; and
sending an approval or decline of the transaction message from the authentication manger to the merchant depending on the response from the customer.

16. A system for authenticating a first party in a transaction between the first party and a second party performed on a communications network, comprises an authentication manager connected to the network, in use the authentication manager performing the steps of claim 1 or claim 15.
